(19) United States
(12) Patent Application Publication
(10) Pub. No.: US 2016/0241052 A1
(43) Pub. Date: Aug. 18, 2016

(54) BATTERY PACK AND BATTERY SYSTEM INCLUDING THE SAME

(71) Applicant: SAMSUNG SDI CO., LTD., Yongin-si (KR)

(72) Inventor: Jongwoon Yang, Yongin-si (KR)

(21) Appl. No.: 14/997,449

(22) Filed: Jan. 15, 2016

(30) Foreign Application Priority Data
Feb. 12, 2015 (KR) 10-2015-0021733

(51) Int. Cl. H02J 7/00

(52) U.S. Cl. CPC H02J 7/007; H02J 7/0021

(57) ABSTRACT

A battery pack includes: at least one battery cell; a first switch; a resistor circuit including a first resistor, and a second resistor connected to the first resistor in parallel and having a larger resistance value than that of the first resistor; a second switch connected to the first switch in parallel and to be turned on to be electrically connected to at least one of the first resistor and the second resistor; and a controller to control charge or discharge of the battery cell by controlling one of the first switch and the second switch to be turned on or off according to a voltage value of the battery cell.

### CROSS-REFERENCE TO RELATED APPLICATION

This application claims priority to and the benefit of Korean Patent Application No. 10-2015-0021733, filed on Feb. 12, 2015, in the Korean Intellectual Property Office, the entire contents of which are incorporated herein by reference in their entirety.

### BACKGROUND

1. Field

One or more example embodiments of the present invention relate to a battery pack and a battery system including the same.

2. Description of the Related Art

A battery is commonly used as an energy source of a mobile device, an electric vehicle, and/or a hybrid vehicle, and a type of the battery varies in accordance with a kind of an applied external device.

A small capacity battery is used for a portable small electronic device, such as a mobile phone, a laptop computer, and/or a camcorder. A large capacity battery may be used for a motor driving power source of the hybrid vehicle and/or the electric vehicle. In this case, when long driving time and high driving power are desired, in order to increase an output and capacity, a plurality of battery cells may be electrically connected to form a large capacity battery module. An output voltage or an output current may be increased in accordance with the number of battery cells mounted in the battery module. A plurality of battery modules may be electrically connected in parallel so that a battery pack may be formed.

When a plurality of battery packs are connected, a deviation (e.g., variation) in charge and discharge voltages of the respective battery cells may be generated in a charge and discharge cycle of the battery pack, so that a specific battery pack may be over-charged during a charging operation or may be over-discharged during a discharging operation. In the plurality of battery packs, when the specific battery pack is over-charged or over-discharged, the capacity of the battery pack may be reduced, the battery pack may deteriorate, and a lifespan of the battery pack may be reduced.

The above information disclosed in this Background section is only for enhancement of understanding of the background of the invention, and therefore, it may contain information that does not form prior art.

### SUMMARY

In the plurality of battery packs, a pre-charge function unit including a pre-charge circuit may be provided in order to stably supply power. When a voltage of a battery cell is very small, a large voltage is distributed to a pre-charge resistance so that rating of the pre-charge resistance is exceeded. Therefore, it may be desirable to increase the rating of the pre-charge resistance in order to stably perform the pre-charge function, although the voltage of the battery cell is very small.

One or more embodiments of the present invention relate to a battery system capable of stably performing a pre-charge function in a rating range of a pre-charge resistor.

One or more embodiments of the present invention relate to a battery system capable of increasing a balancing current of a battery pack when a hot swap function is performed to reduce a balancing performing time.

According to an embodiment of the present invention, a battery system includes: a plurality of battery packs connected in parallel, each of the battery packs including: at least one battery cell; a first switch; a resistor circuit including a first resistor, and a second resistor connected to the first resistor in parallel and having a larger resistance value than that of the first resistor; a second switch connected to the first switch in parallel and configured to be turned on to be electrically connected to at least one of the first resistor and the second resistor; a communicator configured to obtain information corresponding to voltage values of other ones of the battery packs; and a controller configured to control charge or discharge of the battery cell in a plurality of charge and discharge modes according to a voltage value of a corresponding one of the battery packs and the voltage values of the other ones of the battery packs obtained by the communicator, the plurality of charge and discharge modes comprising a first charge and discharge mode in which the first switch is turned on, a second charge and discharge mode in which the second switch is turned on to be electrically connected to the first resistor, and a third charge and discharge mode in which the second switch is turned on to be electrically connected to the second resistor.

The controller may be configured to control the battery cell to be charged or discharged in the third charge and discharge mode when a lowest voltage value of the battery cell is less than or equal to a predetermined voltage value.

The controller may be configured to control the battery cell to be charged or discharged in the second charge and discharge mode when it is determined that the corresponding ones of the battery packs is to be voltage balanced, and to control the battery cell to be charged or discharged in the first charge and discharge mode when it is determined that the corresponding ones of the battery packs is not to be voltage balanced.

At least one of the plurality of battery packs may be voltage balanced when a potential difference exists among the voltage values of the plurality of battery packs.

A number of battery packs from among the plurality of battery packs not to be voltage balanced may be greater than a number of battery packs from among the plurality of battery packs to be voltage balanced.

The plurality of battery packs may be configured to be discharged when voltage values of the battery packs to be voltage balanced are smaller than voltage values of the battery packs not to be voltage balanced, so that a voltage variation among the plurality of battery packs may be reduced.

The plurality of battery packs may be configured to be charged when voltage values of the battery packs to be voltage balanced are larger than voltage values of the battery packs not to be voltage balanced, so that a voltage variation among the plurality of battery packs may be reduced.

According to another embodiment of the present invention, a battery pack includes: at least one battery cell; a first switch; a resistor circuit including a first resistor, and a second resistor connected to the first resistor in parallel and having a larger resistance value than that of the first resistor; a second switch connected to the first switch in parallel and configured to be turned on to be electrically connected to at least one of the first resistor and the second resistor; and a controller configured to control charge or discharge of the battery cell by controlling one of the first switch and the second switch to be turned on or off according to a voltage value of the battery cell.

The controller may be configured to control the first switch to be turned on so that the battery cell is normally charged or discharged.

The first resistor may include a balancing resistor, and the controller may be configured to control the second switch to be electrically connected to the first resistor to reduce a speed at which the battery cell is charged or discharged to perform voltage balancing.

The second resistor may include a pre-charging resistor, and the controller may be configured to control the second switch to be electrically connected to the second resistor when a lowest voltage value of the battery cell is less than or equal to a predetermined value.

According to one or more embodiments of the present invention, the pre-charge function may be stably performed in the rating range of the pre-charge resistor.

In addition, the balancing current of the battery pack may be increased when the hot swap function is performed, so that the balancing performing time may be reduced.

### BRIEF DESCRIPTION OF THE DRAWINGS

Example embodiments will now be described more fully hereinafter with reference to the accompanying drawings. However, the present invention may be embodied in various different forms, and should not be construed as limited to the embodiments set forth herein. Rather, these embodiments are provided so that this disclosure will be thorough and complete, and will full convey the spirit and scope of the present invention to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 illustrates a schematic configuration of a battery system according to an embodiment of the present invention;

FIG. 2 illustrates a configuration of the battery pack in the battery system of FIG. 1;

FIG. 3 illustrates switch control for performing a voltage balancing function according to an embodiment of the present invention; and

FIG. 4 illustrates switch control for performing a pre-charge function according to an embodiment of the present invention.

### DETAILED DESCRIPTION

Hereinafter, example embodiments will be described in more detail with reference to the accompanying drawings. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described with respect to some of the embodiments of the present invention. Unless otherwise noted, like reference numerals denote like elements throughout the attached drawings and the written description, and thus, descriptions thereof may not be repeated.

### Configuration of Battery System

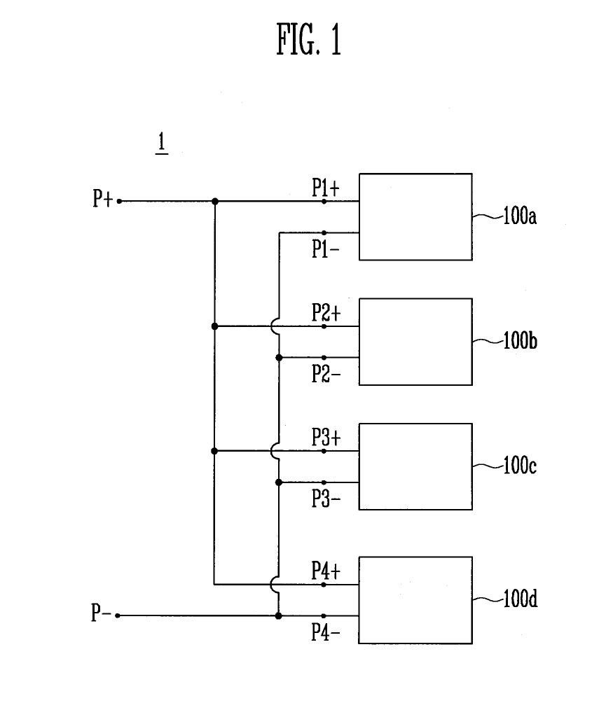

FIG. 1 illustrates a schematic configuration of a battery system 1 according to an embodiment of the present invention.

As illustrated in FIG. 1, the battery system 1 according to an embodiment of the present invention may include a plurality of battery packs 100a, 100b, 100c, and 100d that are connected in parallel. Positive electrode terminals P1+, P2+, P3+, and P4+ of the respective battery packs 100a, 100b, 100c, and 100d may be connected to a first bus bar, and negative electrode terminals P1−, P2−, P3−, and P4− of the respective battery packs 100a, 100b, 100c, and 100d may be connected to a second bus bar, so that the battery packs 100a, 100b, 100c, and 100d may be connected in parallel. In addition, the battery system 1 may be connected to an external load or a power source supplying unit (or power source supply or power supply) through the battery system terminals P+ and P−.

The respective battery packs 100a, 100b, 100c, and 100d may communicate with each other, so that each of the battery packs 100a, 100b, 100c, and 100d may obtain information items on voltage values of the other battery packs 100a, 100b, 100c, and 100d, which may be performed by communication units (e.g., communicators) of the battery packs 100a, 100b, 100c, and 100d to be described later. When one battery pack (for example, the battery pack 100a) obtains information items on voltage values of the other battery packs 100b, 100c, and 100d, it may be determined whether or not the battery pack 100a is to be balanced, so that the battery pack 100a may be charged or discharged in accordance with the determination result.

Configurations and charge or discharge control functions of the battery packs 100a, 100b, 100c, and 100d according to an embodiment of the present invention will be described in more detail hereinafter.

While in FIG. 1, the four battery packs 100a, 100b, 100c, and 100d are illustrated as being connected in parallel, the present invention is not limited thereto, and the number of battery packs connected in parallel may be changed.

### Configuration of Battery Pack

Hereinafter, an internal configuration of a battery pack according to the present invention and functions of the respective elements will be described.

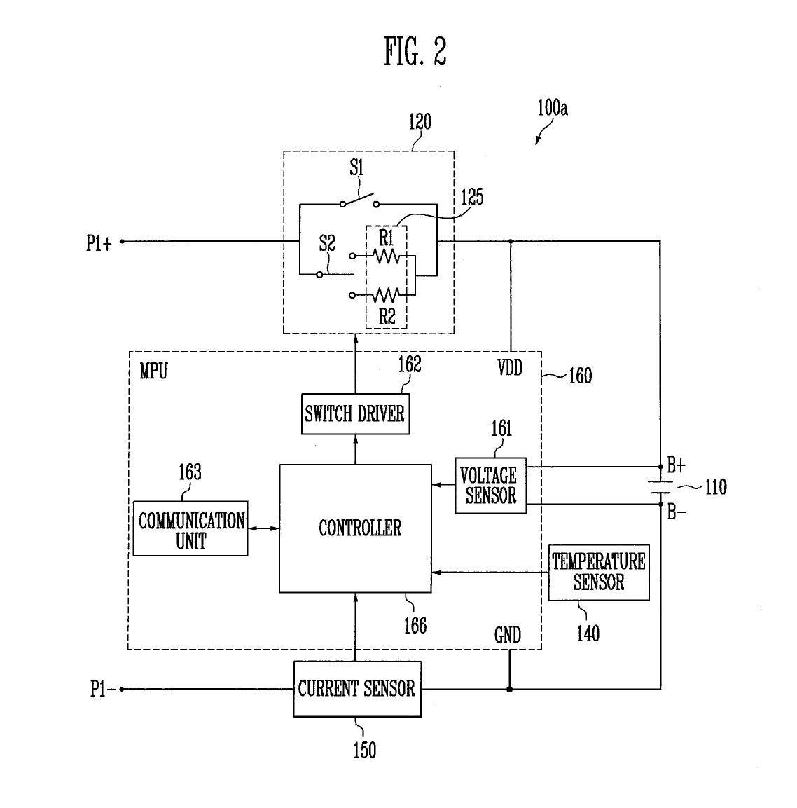

FIG. 2 illustrates a configuration of the battery pack 100a in the battery system of FIG. 1. Each of the battery packs 100a, 100b, 100c, and 100d in FIG. 1 may include the same or substantially the same configurations and functions as illustrated in FIG. 2.

As illustrated in FIG. 2, the battery pack 100a according to an embodiment of the present invention may include a battery 110, a charge and discharge switch unit (e.g., a charge and discharge switch circuit) 120, a temperature sensor 140, a current sensor 150, and a micro-processor unit (MPU) 160. In addition, the battery pack 100a may be connected to the other battery packs 100b, 100c, and 100d through the pack terminals P1+ and P1−.

The battery 110 may include at least one battery cell. A secondary battery that may be charged and discharged in accordance with consumption or supply of electric energy may be used as the battery cell. For example, the secondary battery may include a nickel-cadmium battery, a lead storage, a nickel metal hydride (NiMH) battery, a lithium ion battery, and/or a lithium polymer battery. A kind of the secondary battery is not limited thereto. In addition, although one battery cell is illustrated in FIG. 2, a plurality of battery cells that are serially connected or that are connected in parallel may be provided.

The charge and discharge switch unit 120 may be provided between a positive electrode terminal B+ of the battery 110 and the positive electrode terminal P1+ of the battery pack. Therefore, when the battery 110 is over-charged or over-discharged, a switch of the charge and discharge switch unit 120 is turned off by a control signal from the MPU 160, so that it may be possible to prevent or substantially prevent the battery 110 from being over-charged and/or over-discharged. The charge and discharge switch unit 120 may be a common metal oxide semiconductor field effect transistor (MOSFET) or a relay. However, the present invention is not limited thereto.

For example, the charge and discharge switch unit 120 according to the present invention may include a first switch S1, a second switch S2, and a resistor unit (e.g., a resistor circuit) 125. As illustrated in FIG. 2, the first switch S1 and the second switch S2 may be connected in parallel, and when the battery 110 is charged or discharged, the first switch S1 or the second switch S2 may be selected according to a control signal output from a switch driver 162 to be turned on or off. The resistor unit 125 may be connected to the second switch S2, and may include a first resistor R1 and a second resistor R2 that are connected in parallel. A resistance value of the second resistor R2 may be larger than that of the first resistor R1. The second switch S2 may be turned on to be electrically connected to the first resistor R1 or the second resistor R2.

According to an embodiment of the present invention, a charge or discharge method may vary in accordance with which switch is turned on between the first switch S1 and the second switch S2. For example, the charge or discharge method may vary in accordance with which switch the second switch S2 is turned on to be electrically connected between the first resistor R1 and the second resistor R2.

For example, when the first switch S1 is turned on, the battery 110 may be normally charged or discharged (hereinafter, referred to as a first charge and discharge mode), and when the second switch S2 is turned on to be connected to the first resistor R1, charge or discharge (hereinafter, referred to as a second charge and discharge mode) for voltage balancing on the battery 110 may be performed. Additionally, when the second switch S2 is turned on to be connected to the second resistor R2, charge or discharge (hereinafter, referred to as a third charge and discharge mode) for pre-charging the battery 110 may be performed.

A controller 166 may control which one of the above-described plurality of charge and discharge modes are performed when charge or discharge of the battery 110 is performed, which will be described in detail later.

The temperature sensor 140 is connected (e.g., directly attached) to the battery 110 or is provided near the battery 110. The temperature sensor 140 senses a temperature of the battery 110 or a peripheral temperature of the battery 110, and transmits the sensed temperature to the MPU 160. The temperature sensor 140 may include, for example, a thermistor. However, the present invention is not limited thereto.

The current sensor 150 may be provided between a negative electrode terminal B− of the battery 110 and the negative electrode terminal P− of the battery pack. The current sensor 150 may sense charge and discharge currents of the battery 110, and may transmit the sensed charge and discharge currents to the MPU 160. The current sensor 150 may include one selected from among a hall sensor, a shunt resistor, and equivalents thereof. However, the present invention is not limited thereto.

The MPU 160 may include a voltage sensor 161, the switch driver 162, a communication unit (e.g., a communicator) 163, and the controller 166. The voltage sensor 161 is connected to the battery 110 in parallel, and senses a terminal voltage of the battery 110. The voltage sensor 161 may convert the sensed terminal voltage into a digital signal, and may transmit the digital signal to the controller 166. When the plurality of battery cells are included in the battery 110, the voltage sensor 161 may sense voltages of the respective battery cells. The current obtained by the current sensor 150 and the temperature obtained by the temperature sensor 140 may be converted into digital signals, and the digital signals may be transmitted to the controller 166.

The communication unit 163 may perform communications with the other battery packs 100b, 100c, and 100d connected to the battery pack 100a in parallel. The battery pack 100a obtains information on a voltage of the battery or voltages of the battery cells that are included in the other battery packs 100b, 100c, and 100d from the communication unit 163, and may transmit the obtained information to the controller 166. The communication unit 163 may perform communications with communication units of the other battery packs 100b, 100c, and 100d by using a controller area network (CAN). However, the present invention is not limited thereto. Since the CAN is known to those skilled in the art, detailed description thereof will not be given.

The switch driver 162 turns on or off the first switch S1 or the second switch S2 of the charge and discharge switch unit 120 according to the control signal from the controller 166. That is, the controller 166 controls the switch driver 162 based on information obtained by the temperature sensor 140, the current sensor 150, the voltage sensor 161, and the communication unit 163.

For example, when the battery 110 is fully charged, the controller 166 transmits the control signal to the switch driver 162, so that the first switch S1 and the second switch S2 of the charge and discharge switch unit 120 are turned off. In addition, when it is determined that an over-current flows through the battery 110 based on the information obtained by the current sensor 150, the controller 166 transmits the control signal to the switch driver 162, so that the first switch S1 and the second switch S2 of the charge and discharge switch unit 120 are turned off. Furthermore, when it is determined that the battery 110 is over-charged and/or over-discharged based on the information obtained by the voltage sensor 161, the controller 166 transmits the control signal to the switch driver 162, so that the first switch S1 and the second switch S2 of the charge and discharge switch unit 120 are turned off.

For example, the controller 166 may control charge or discharge of the battery 110 with reference to information items on voltage values of the battery cells that are obtained by the voltage sensor 161, and information items on voltage values of the battery cells included in the other battery packs 100b, 100c, and 100d that are obtained by the communication unit 163. The controller 166 may perform control so that the battery 110 is charged or discharged in one of the first to third charge and discharge modes.

During charging of the battery 110, when a charge current is received by a battery cell whose voltage is excessively reduced, abnormal heat may be generated. In order to prevent or substantially prevent the abnormal heat from being generated, a pre-charge function is performed, so that the respective battery cells are slowly charged to have predetermined values (for example, 2.5V to 3V) by using a pre-charge circuit including a pre-charge resistor. According to an embodiment of the present invention, the above-described pre-charge circuit may include the second switch S2 and the resistor unit 125.

When a lowest voltage of the battery cells included in the battery 110 is not greater than (e.g., less than or equal to) a predetermined voltage value, the controller 166 may perform control so that the second switch S2 is turned on to be electrically connected to the resistor unit 125 in order to perform the pre-charge. When rating of a resistor used as a pre-charge resistor is low, or a resistance value is small, the rating of the pre-charge resistor is exceeded when the pre-charge function is performed.

For example, when voltages of the respective battery cells are 2.0V, a terminal voltage of the battery including the plurality of battery cells is 28V (when 14 battery cells are serially connected). Further, when the battery system is connected to an external device (or a power source supplying unit or a power source supply or a power supply), so that a terminal voltage of the battery pack is 56V, a voltage of 28V may be distributed to the pre-charge resistor. When it is determined that a specification of the pre-charge resistor is, for example, 15 W, 30 ohm, since power applied to the pre-charge resistor is 26 W, the rating of the pre-charge resistor is exceeded.

Therefore, although a terminal voltage value of the battery 110 is small so that a high voltage is distributed to the pre-charge circuit, in order to prevent or substantially prevent the rating of the pre-charge resistor from being exceeded, a pre-charge resistor with a high rating or a pre-charge resistor with a large resistance value may be desirable in order to reduce a magnitude of power applied to the pre-charge resistor. Since the pre-charge resistor with high rating has a large size, in order to prepare a space in which the pre-charge resistor is to be mounted, sizes of parts also increase. Therefore, in order to maintain the parts to be small, while preventing or substantially preventing the rating from being exceeded, and thus, to prevent or substantially prevent heat from being generated, a resistor with a large resistance value may be provided as the pre-charge resistor.

On the other hand, like the battery system 1 according to an embodiment of the present invention, a battery system (for example, a battery system provided in an energy storage system for communications) in which the plurality of battery packs 100a, 100b, 100c, and 100d are connected in parallel may include a hot swap function of exchanging at least one of the battery packs 100a, 100b, 100c, and 100d while driving the battery system 1. After exchanging the battery pack, when a potential difference exists between the battery packs included in the battery system 1 and a new battery pack, a voltage matching (or voltage balancing) function is to be performed. In this case, the pre-charge circuit according to an embodiment of the present invention may be used.

That is, when the pre-charge circuit according to the present invention is used, since a speed at which charge or discharge is performed is lower than a speed at which normal charge or discharge is performed (charge or discharge is performed when the first switch is turned on), charge or discharge is performed on some of the plurality of battery packs by using the pre-charge circuit and normal charge or discharge is performed on the remaining battery packs. Therefore, a potential difference between the battery packs may be gradually reduced as charge or discharge is repeated.

When the above-described pre-charge circuit including large resistance is used for performing voltage balancing on the battery packs, since a magnitude of the current that flows through the battery is reduced in comparison with the case in which the pre-charge circuit including small resistance is used, balancing time increases.

Therefore, in the pre-charge circuit including the resistor, in order to electrically connect the resistor with the large resistance value when charge or discharge for pre-charging is performed, and to electrically connect the resistor with the small resistance value when charge or discharge for balancing is performed, the resistor for pre-charging and the resistor for balancing may be connected in parallel. That is, according to the present invention, it may be possible to prevent or substantially prevent the rating of the resistor from being exceeded while pre-charging is performed, and to reduce balancing time while balancing is performed.

According to an embodiment of the present invention, the first resistor R1 may be used as the above-described balancing resistor, the second resistor R2 may be used as the pre-charging resistor, and as described above, the resistance value of the second resistor R2 may be larger than that of the first resistor R1.

Hereinafter, referring to FIGS. 2 to 4, the first to third charge and discharge modes applied to the battery packs 100a, 100b, 100c, and 100d included in the battery system 1 according to an embodiment of the present invention will be described in more detail.

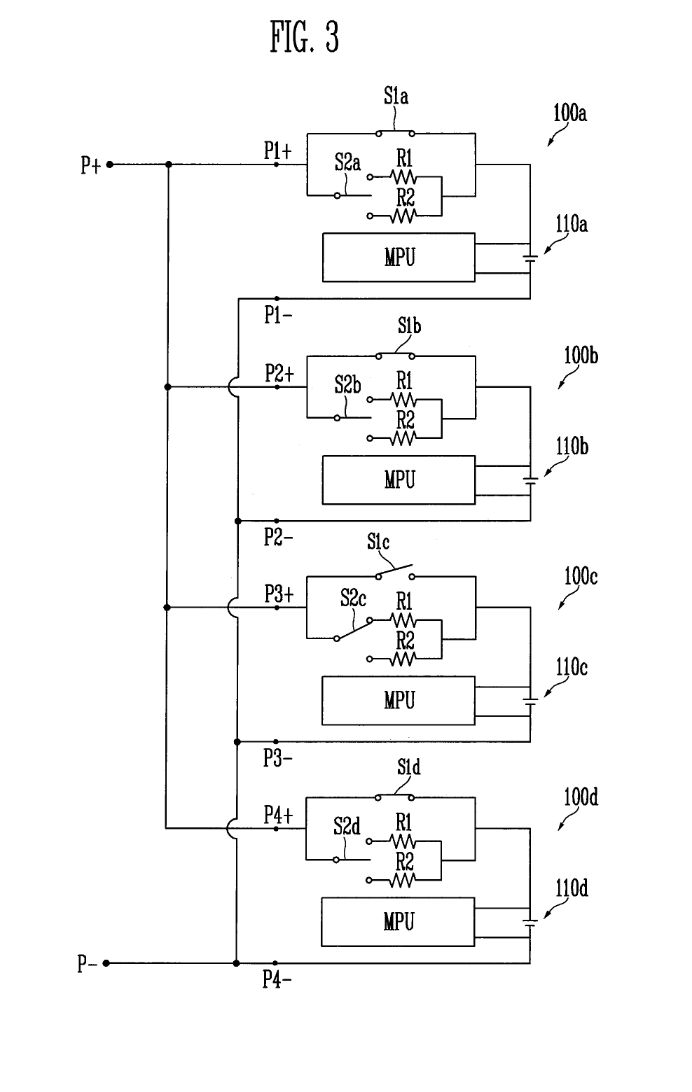

FIG. 3 illustrates switch control for performing a voltage balancing function according to an embodiment of the present invention.

As illustrated in FIG. 3, in the battery system including the battery packs 100a, 100b, 100c, and 100d connected in parallel, the plurality of battery packs 100a, 100b, 100c, and 100d may exchange the information items on the voltage values of the battery cells through the communication units. The controller of each the plurality of battery packs 100a, 100b, 100c, and 100d obtains the information items on the voltage values of the battery cells included in the other battery packs, and may compare the information items on the voltage values of the battery cells included in the battery pack in charge thereof with the information items on the voltage values of the battery cells included in the other battery packs. When it is determined that a potential difference exists between the terminal voltages (or the voltages of the battery cells) of the plurality of battery packs 100a, 100b, 100c, and 100d, the controller of each of the plurality of battery packs 100a, 100b, 100c, and 100d determines whether the battery packs are to be voltage balanced.

When it is determined that the plurality of battery packs 100a, 100b, 100c, and 100d are to be divided into a first group that includes a set of battery packs with large voltage values and a second group that includes a set of battery packs with small voltage values, the group with a smaller number of battery packs between the first and second groups may be voltage balanced. That is, when the controller determines that the battery packs in charge thereof belong to the group with the smaller number of battery packs, the controller determines that the battery packs are to be voltage balanced, and may output the control signal so that the second switch S2 is turned on to be electrically connected to the first resistor R1. When the controller determines that the battery packs in charge thereof belong to the group with the larger number of battery packs, the controller determines that the battery packs are not to be voltage balanced, and may output the control signal so that the first switch S1 is turned on.

For example, in the battery system according to an embodiment of the present invention, when the battery pack 100c is exchanged (e.g., swapped out), a potential difference may occur between the exchanged battery pack 100c and the battery packs 100a, 100b, and 100d. In this case, as illustrated in FIG. 3, the battery packs 100a, 100b, and 100d are charged or discharged in the first charge and discharge mode, and the exchanged battery pack 100c is charged or discharged in the second charge and discharge mode so that voltage balancing may be performed.

When the voltage value of the exchanged battery pack 100c is smaller than those of the battery packs 100a, 100b, and 100d, since the exchanged battery pack 100c is more slowly discharged than the battery packs 100a, 100b, and 100d, it may be possible to reduce a potential difference between the exchanged battery pack 100c and the battery packs 100a, 100b, and 100d when the battery system is discharged. When the voltage value of the exchanged battery pack 100c is larger than those of the battery packs 100a, 100b, and 100d, since the exchanged battery pack 100c is more slowly charged than the battery packs 100a, 100b, and 100d, it may be possible to reduce the potential difference between the exchanged battery pack 100c and the battery packs 100a, 100b, and 100d when the battery system is charged.

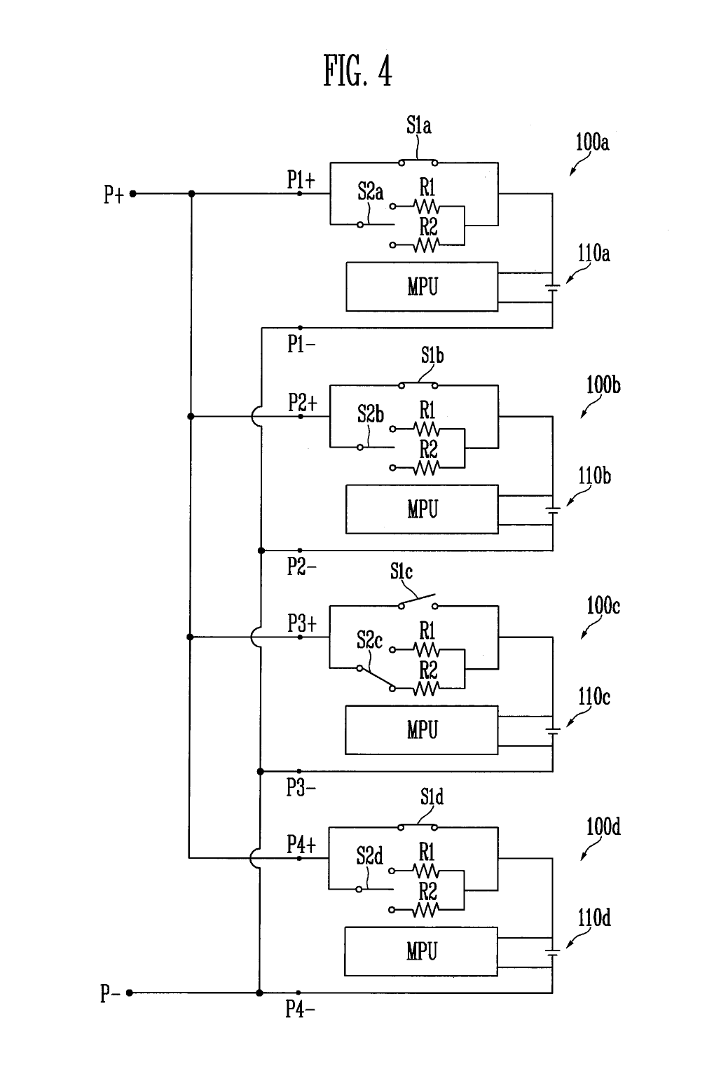

FIG. 4 illustrates switch control for performing a pre-charge function according to an embodiment of the present invention.

In the battery system including the battery packs 100a, 100b, 100c, and 100d that are connected in parallel, the controller of each the plurality of battery packs 100a, 100b, 100c, and 100d may obtain the information items on the voltage values of the battery cells included in the battery pack in charge thereof. When the lowest voltage of the battery cells is not greater than (e.g., less than or equal to) a predetermined voltage value, the controller may output the control signal so that the second switch S2 is turned on to be electrically connected to the second resistor R2. That is, as illustrated in FIG. 4, a specific battery pack (for example, the battery pack 100c) having battery cells whose lowest voltage is not greater than a predetermined value is charged in a third charge mode in which a second switch S2c is electrically connected to a second resistor R2. The remaining battery packs 100a, 100b, and 100d (battery packs in which a lowest voltage of battery cells is greater than the predetermined value and voltages values are the same or substantially the same) excluding the specific battery pack 100c may be charged in the first charge mode.

For example, in the battery system according to an embodiment of the present invention, when the battery pack 100c is exchanged (e.g., swapped out), a potential difference may occur between the exchanged battery pack 100c and the battery packs 100a, 100b, and 100d. In this case, as illustrated in FIG. 3, the battery packs 100a, 100b, and 100d are charged or discharged in the first charge and discharge mode, and the exchanged battery pack 100c is charged or discharged in the second charge and discharge mode so that voltage balancing may be performed.

When the voltage value of the exchanged battery pack 100c is smaller than those of the battery packs 100a, 100b, and 100d, since the exchanged battery pack 100c is more slowly discharged than the battery packs 100a, 100b, and 100d, it may be possible to reduce a potential difference between the exchanged battery pack 100c and the battery packs 100a, 100b, and 100d when the battery system is discharged. When the voltage value of the exchanged battery pack 100c is larger than those of the battery packs 100a, 100b, and 100d, since the exchanged battery pack 100c is more slowly charged than the battery packs 100a, 100b, and 100d, it may be possible to reduce the potential difference between the exchanged battery pack 100c and the battery packs 100a, 100b, and 100d when the battery system is charged.

Example embodiments have been disclosed herein, and although specific terms are employed, they are used and are to be interpreted in a generic and descriptive sense only and not for purpose of limitation.

It will be understood that, although the terms “first,” “second,” “third,” etc., may be used to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

In some instances, as would be apparent to those of ordinary skill in the art as of the filing of the present application, features, characteristics, and/or elements described in connection with a particular embodiment may be used singly or in combination with features, characteristics, and/or elements described in connection with other embodiments, unless otherwise specifically indicated. Accordingly, it will be understood by those of skill in the art that various changes in form and details may be made without departing from the spirit and scope of the present invention as set forth in the following claims, and their equivalents.

What is claimed is:

1. A battery system comprising:
a plurality of battery packs connected in parallel, each of the battery packs comprising:
at least one battery cell;
a first switch;
a resistor circuit comprising a first resistor, and a second resistor connected to the first resistor in parallel and having a larger resistance value than that of the first resistor;
a second switch connected to the first switch in parallel and configured to be turned on to be electrically connected to at least one of the first resistor and the second resistor;
a communicator configured to obtain information corresponding to voltage values of other ones of the battery packs; and
a controller configured to control charge or discharge of the battery cell in a plurality of charge and discharge modes according to a voltage value of a corresponding one of the battery packs and the voltage values of the other ones of the battery packs obtained by the communicator, the plurality of charge and discharge modes comprising a first charge and discharge mode in which the first switch is turned on, a second charge and discharge mode in which the second switch is turned on to be electrically connected to the first resistor, and a third charge and discharge mode in which the second switch is turned on to be electrically connected to the second resistor.

2. The battery system of claim 1, wherein the controller is configured to control the battery cell to be charged or discharged in the third charge and discharge mode when a lowest voltage value of the battery cell is less than or equal to a predetermined voltage value.

3. The battery system of claim 1, wherein the controller is configured to control the battery cell to be charged or discharged in the second charge and discharge mode when it is determined that the corresponding one of the battery packs is to be voltage balanced, and to control the battery cell to be charged or discharged in the first charge and discharge mode when it is determined that the corresponding one of the battery packs is not to be voltage balanced.

4. The battery system of claim 3, wherein at least one of the plurality of battery packs is to be voltage balanced when a potential difference exists among the voltage values of the plurality of battery packs.

5. The battery system of claim 4, wherein a number of battery packs from among the plurality of battery packs not to be voltage balanced is greater than a number of battery packs from among the plurality of battery packs to be voltage balanced.

6. The battery system of claim 4, wherein the plurality of battery packs are configured to be discharged when voltage values of the battery packs to be voltage balanced are smaller than voltage values of the battery packs not to be voltage balanced, so that a voltage variation among the plurality of battery packs is reduced.

7. The battery system of claim 4, wherein the plurality of battery packs are configured to be charged when voltage values of the battery packs to be voltage balanced are larger than voltage values of the battery packs not to be voltage balanced, so that a voltage variation among the plurality of battery packs is reduced.

8. A battery pack comprising:
at least one battery cell;
a first switch;
a resistor circuit comprising a first resistor, and a second resistor connected to the first resistor in parallel and having a larger resistance value than that of the first resistor;
a second switch connected to the first switch in parallel and configured to be turned on to be electrically connected to at least one of the first resistor and the second resistor; and
a controller configured to control charge or discharge of the battery cell by controlling one of the first switch and the second switch to be turned on or off according to a voltage value of the battery cell.

9. The battery pack of claim 8, wherein the controller is configured to control the first switch to be turned on so that the battery cell is normally charged or discharged.

10. The battery pack of claim 9,
wherein the first resistor comprises a balancing resistor, and
wherein the controller is configured to control the second switch to be electrically connected to the first resistor to reduce a speed at which the battery cell is charged or discharged to perform voltage balancing.

11. The battery pack of claim 9,
wherein the second resistor comprises a pre-charging resistor, and
wherein the controller is configured to control the second switch to be electrically connected to the second resistor when a lowest voltage value of the battery cell is less than or equal to a predetermined value.
